(19) United States
(12) Patent Application Publication
(10) Pub. No.: US 2024/0323795 A1
(43) Pub. Date: Sep. 26, 2024

(54) APPARATUS AND METHOD TO SIGNAL CONFIGURATION FOR LOWER LAYER TRIGGERED MOBILITY IN NEXT GENERATION MOBILE WIRELESS COMMUNICATION SYSTEMS

(71) Applicant: Samsung Electronics Co., Ltd., Suwon-si (KR)

(72) Inventors: June HWANG, Suwon-si (KR); Seungri JIN, Suwon-si (KR)

(21) Appl. No.: 18/612,103

(22) Filed: Mar. 21, 2024

(30) Foreign Application Priority Data
Mar. 22, 2023 (KR) 10-2023-0037527

(51) Int. Cl. H04W 36/32; H04W 36/00; H04W 76/27

(52) U.S. Cl. CPC H04W 36/324; H04W 36/0072; H04W 76/27

(57) ABSTRACT

A method performed by a terminal in a wireless communication system is provided. The method includes identifying that a lower layer triggered mobility (LTM) cell switch is triggered, identifying a reference configuration and a candidate configuration associated with LTM, identifying whether information indicating that the candidate configuration is a complete configuration is included in the candidate configuration, and applying a radio resource control (RRC) reconfiguration message for the LTM cell switch, wherein the RRC reconfiguration message is based on at least one of the reference configuration or the candidate configuration depending on whether the information indicating that the candidate configuration is the complete configuration is included in the candidate configuration.

### CROSS-REFERENCE TO RELATED APPLICATION(S)

This application is based on and claims priority under 35 U.S.C. § 119(a) of a Korean patent application number 10-2023-0037527, filed on Mar. 22, 2023, in the Korean Intellectual Property Office, the disclosure of which is incorporated by reference herein in their entirety.

### BACKGROUND

### 1. Field

The disclosure relates to the operation of a terminal in a mobile communication system. More particularly, the disclosure relates to a method for transferring configuration for the mobility of a terminal.

### 2. Description of Related Art

5^{th} generation (5G) mobile communication technologies define broad frequency bands such that high transmission rates and new services are possible, and can be implemented not only in “Sub 6 GHz” bands, such as 3.5 GHZ, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular Momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

As various services can be provided as described above and with the development of mobile communication systems, there is a need for a method to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a specific method on how a terminal can move to a target cell based on what configuration when the terminal desires to perform a lower layer triggered movement operation.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes identifying that a lower layer triggered mobility (LTM) cell switch is triggered, identifying a reference configuration and a candidate configuration associated with LTM, identifying whether information indicating that the candidate configuration is a complete configuration is included in the candidate configuration, and applying a radio resource control (RRC) reconfiguration message for the LTM cell switch, wherein the RRC reconfiguration message is based on at least one of the reference configuration or the candidate configuration depending on whether the information indicating that the candidate configuration is the complete configuration is included in the candidate configuration.

In accordance with another aspect of the disclosure, a method performed by a base station (BS) in a wireless communication system is provided. The method includes transmitting, to a terminal, a reference configuration and a candidate configuration associated with lower LTM, determining to trigger a LTM cell switch, and transmitting, to the terminal, command information for the LTM cell switch, wherein an RRC reconfiguration message for the LTM cell switch is based on at least one of the reference configuration or the candidate configuration depending on whether information indicating that the candidate configuration is a complete configuration is included in the candidate configuration.

In accordance with another aspect of the disclosure, a terminal in a wireless communication system is provided. The terminal includes a transceiver and a controller configured to identify that a lower LTM cell switch is triggered, identify a reference configuration and a candidate configuration associated with LTM, identify whether information indicating that the candidate configuration is a complete configuration is included in the candidate configuration, and apply an RRC reconfiguration message for the LTM cell switch, wherein the RRC reconfiguration message is based on at least one of the reference configuration or the candidate configuration depending on whether the information indicating that the candidate configuration is the complete configuration is included in the candidate configuration.

In accordance with another aspect of the disclosure, a base station in a wireless communication system is provided. The base station includes a transceiver and a controller configured to transmit, to a terminal, a reference configuration and a candidate configuration associated with lower LTM, determine to trigger a LTM cell switch, and transmit, to the terminal, command information for the LTM cell switch, wherein an RRC reconfiguration message for the LTM cell switch is based on at least one of the reference configuration or the candidate configuration depending on whether information indicating that the candidate configuration is a complete configuration is included in the candidate configuration.

According to embodiments of the disclosure, when receiving the configuration of multiple target cells, a terminal transfers the target cell configuration in a scheme of adding other configuration based on reference configuration, thereby reducing signal overhead.

Further, according to an embodiment of the disclosure, the candidate configuration can be used as a complete configuration when operating an LTM cell switch, and target cell configuration can be efficiently performed.

In accordance with another aspect of the disclosure, one or more non-transitory computer-readable storage media storing computer-executable instructions that, when executed by one or more processors of a terminal, cause the terminal to perform operations are provided. The operations include identifying that an LTM cell switch is triggered, identifying a reference configuration and a candidate configuration associated with LTM, identifying whether information indicating that the candidate configuration is a complete configuration is included in the candidate configuration, and applying an RRC reconfiguration message for the LTM cell switch, wherein the RRC reconfiguration message is based on at least one of the reference configuration or the candidate configuration depending on whether the information indicating that the candidate configuration is the complete configuration is included in the candidate configuration.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure in long term evolution (LTE) system according to an embodiment of the disclosure;

FIG. 2 illustrates a radio protocol structure in an LTE system according to an embodiment of the disclosure;

FIG. 3 illustrates a structure in a next-generation mobile communication system according to an embodiment of the disclosure;

FIG. 4 illustrates a radio protocol structure in a next-generation mobile communication system according to an embodiment of the disclosure;

FIG. 5 illustrates a structure of a terminal in a wireless communication system according to an embodiment of the disclosure;

FIG. 6 is a block diagram illustrating a configuration of a base station in a wireless communication system according to an embodiment of the disclosure;

FIG. 7 illustrates an operation of basic lower layer triggered mobility according to an embodiment of the disclosure;

FIG. 8 illustrates a scheme of forming a complete configuration when a reference configuration and a candidate delta configuration are applied according to an embodiment of the disclosure;

FIG. 9 illustrates a user equipment (UE) operation to make a complete configuration when a reference configuration and a candidate delta configuration are given according to an embodiment of the disclosure; and

FIG. 10 illustrates a process of making a complete configuration when an RRCReconfiguration message of a current UE is a reference configuration according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, a BS is an entity that allocates resources to terminals, and may be at least one of a gNode B, an eNode B, a Node B, a BS, a wireless access unit, a BS controller, and a node on a network. A terminal may include a UE, a mobile station (MS), a cellular phone, a smartphone, a computer, or a multimedia system capable of performing communication functions. In the disclosure, a “downlink” refers to a radio link via which a BS transmits a signal to a terminal, and an “uplink” refers to a radio link via which a terminal transmits a signal to a BS. Further, although the following description may be directed to a long term evolution (LTE) or long term evolution advanced (LTE-A) system by way of example, embodiments of the disclosure may also be applied to other communication systems having similar technical backgrounds or channel types to the embodiments of the disclosure. Examples of other communication systems may include 5G new radio (NR) developed beyond LTE-A, and in the following description, “5G” may be a concept that covers exiting LTE, LTE-A, and other similar services. In addition, based on determinations by those skilled in the art, the disclosure may be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create a means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of order. For example, two blocks shown in succession may in fact be executed concurrently or the blocks may sometimes be executed in the reverse order, depending upon the functionality involved.

As used herein, “unit” refers to a software element or a hardware element, such as a field programmable gate array (FPGA) or an application specific integrated circuit (ASIC), which performs a predetermined function. However, the term “unit” does not always have a meaning limited to software or hardware. “Unit” may be constructed either to be stored in an addressable storage medium or to execute one or more processors. Therefore, “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may either be combined into a smaller number of elements, or a “unit”, or divided into a larger number of elements, or a “unit”. Moreover, the elements and “units” may be implemented to reproduce one or more CPUs within a device or a security multimedia card. Further, the term “unit” in the embodiments may include one or more processors.

In the following description, the disclosure will be described using terms and names defined in 5GS and NR standards, which are standards defined by the 3rd generation partnership project (3GPP) organization among currently existing communication standards for the convenience of description. However, the disclosure is not limited by these terms and names, and may be applied in the same way to wireless communication networks that conform other standards. For example, the disclosure can be applied to 3GPP 5GS/NR (5th generation mobile communication standard).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

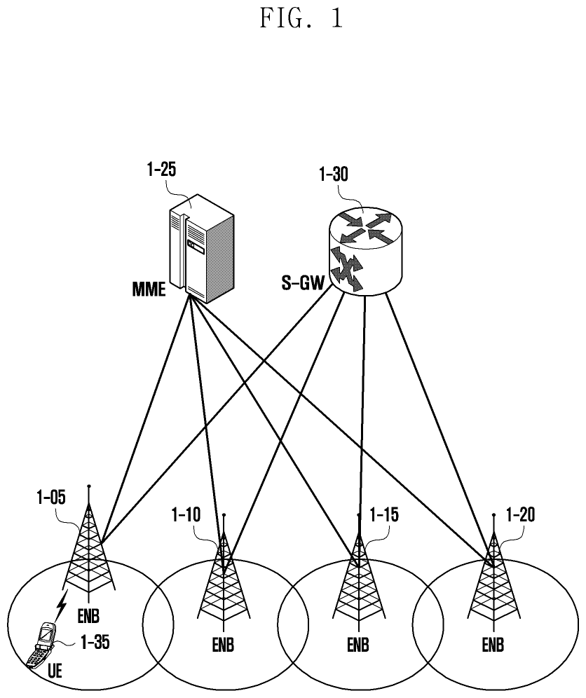

FIG. 1 illustrates a structure in an LTE system according to an embodiment of the disclosure.

Referring to FIG. 1, a wireless access network of the LTE system may include next-generation base stations (evolved Node Bs, hereinafter, referred to as “ENBs”, “Node Bs”, or “base stations”) 1-05, 1-10, 1-15, and 1-20, a mobility management entity (MME) 1-25, and a serving-gateway (S-GW) 1-30. A user equipment (hereinafter, referred to as a “UE” or a “terminal”) 1-35 may access an external network through the ENBs 1-05 to 1-20 and the S-GW 1-30.

In FIG. 1, the ENBs 1-05 to 1-20 may correspond to the existing Node Bs of a universal mobile telecommunication system (UMTS). The ENB may be connected to the UE 1-35 via a radio channel, and may perform more complex functions than the existing Node B. In the LTE system, all user traffics including real-time services, such as voice over Internet protocol (VOIP) may be serviced through a shared channel. Accordingly, a device for collecting state information, such as buffer state information of UEs, available transmission power state information of UEs, and channel state information of UEs, and performing scheduling may be required, and each of the ENBs 1-05 to 1-20 may serve as such a device. A single ENB may generally control multiple cells. For example, the LTE system uses a radio-access technology, such as orthogonal frequency-division multiplexing (OFDM) in a bandwidth of 20 MHz to achieve a data rate of 100 Mbps. In addition, the ENB may also apply an adaptive modulation & coding (AMC) scheme for determining a modulation scheme and a channel-coding rate in accordance with the channel state of a terminal. The S-GW 130 is a device for providing a data bearer, and may generate or release the data bearer under the control of the MME 1-25. The MME is a device for performing a mobility management function and various control functions for a terminal, and may be connected to multiple base stations.

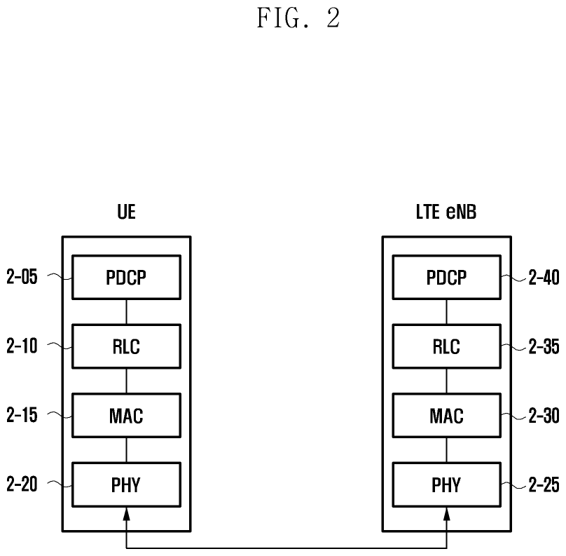

FIG. 2 illustrates a radio protocol structure in an LTE system according to an embodiment of the disclosure.

Referring to FIG. 2, the radio protocol in the LTE system includes packet data convergence protocols (PDCPs) 2-05 and 2-40, radio link controls (RLCs) 2-10 and 2-35, medium access controls (MACs) 2-15 and 2-30, and physical (PHY) devices in a terminal and an ENB, respectively. The PDCPs may perform operations of IP header compression/recovery and the like. The main function of the PDCP is summarized below but are not limited thereto:
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based service data unit (SDU) discard in uplink.

The radio link controls (RLCs) 2-10 and 2-35 may reconfigure the PDCP protocol data unit (PDU) at an appropriate size to perform an automatic repeat request (ARQ) operation or the like. The main functions of the RLC are summarized below but are not limited thereto:
Transfer of upper layer PDUs
Error Correction through automatic repeat request (ARQ) (only for AM data transfer)
Concatenation, segmentation, and reassembly of RLC SDUs (only for unacknowledged mode (UM) and AM data transfer)
Re-segmentation of RLC data PDUs (only for AM data transfer)
Reordering of RLC data PDUs (only for UM and AM data transfer
Duplicate detection (only for UM and AM data transfer)
Protocol error detection (only for AM data transfer)
RLC SDU discard (only for UM and AM data transfer)
RLC re-establishment.

The MACs 2-15 and 2-30 are connected to several RLC layer devices configured in one terminal, and may perform an operation of multiplexing RLC PDUs into a MAC PDU and demultiplexing the RLC PDUs from the MAC PDU. The main functions of the MAC are summarized below but are not limited thereto:
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

Physical layers (PHYs) 2-20 and 2-25 may generate an OFDM symbol by performing channel-coding and modulating upper-layer data and transmit the same through a radio channel, or may perform demodulating and channel-decoding the OFDM symbol received through the radio channel and transmit the same to an upper layer.

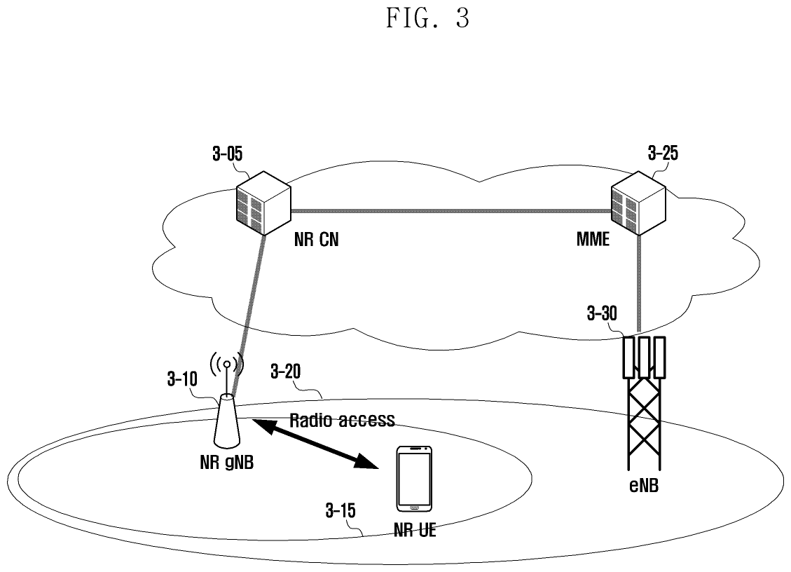

FIG. 3 illustrates a structure in a next-generation mobile communication system according to an embodiment of the disclosure.

Referring to FIG. 3, a radio access network in the next-generation mobile communication system (hereinafter referred to as “new radio (NR)” or 5G) may include a new-radio base station (a new-radio node B, hereinafter, referred to as an “NR gNB” or an “NR base station”) 3-10 and a new-radio core network (NR CN) 3-05. A new-radio user equipment (hereinafter, referred to as an “NR UE” or an “NR terminal”) 3-15 may access an external network through the NR gNB 3-10 and the NR CN 3-05.

In FIG. 3, the NR gNB 3-10 may correspond to an evolved node B (eNB) in the existing LTE system. The NR gNB 3-10 may be connected to the NR UE 3-15 through a radio channel, and thus may provide service superior to that of the existing node B. In the next-generation mobile communication system, all user traffic is serviced through shared channels in the next-generation mobile communication system. Accordingly, a device for collecting state information, such as buffer state information of UEs, available transmission power state information of UEs, and channel state information of UEs, and performing scheduling is required, and the NR gNB 3-10 may serve as such a device. A single NR gNB 3-10 may generally control multiple cells. In order to implement ultra-high-speed data transmission in the next-generation mobile communication system as compared with the existing LTE, a bandwidth that is equal to or higher than the existing maximum bandwidth may be applied. In addition, a beamforming technology may be additionally combined using orthogonal frequency-division multiplexing (OFDM) as radio connection technology. In addition, an adaptive modulation & coding (AMC) scheme that determines a modulation scheme and a channel-coding rate in accordance with the channel state of the terminal may be applied. The NR CN 3-05 may perform a function, such as mobility support, bearer configuration, and quality of service (QOS) configuration. The NR CN 3-05 is a device that performs not only terminal mobility management functions but also various types of control functions, and may be connected to multiple base stations. Further, the next-generation mobile communication system may be linked with the existing LTE system, and the NR CN 3-05 may be connected to the MME 3-25 through a network interface. The MME 3-25 is connected to an eNB 3-30, that is, the LTE base station.

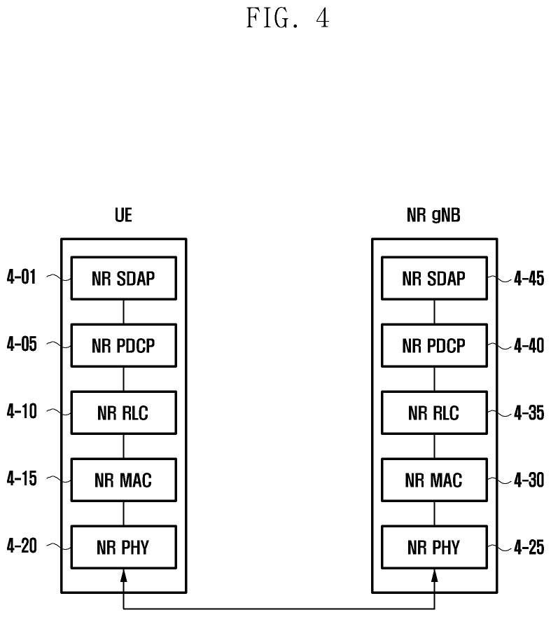

FIG. 4 illustrates a radio protocol structure in a next-generation mobile communication system according to an embodiment of the disclosure.

Referring to FIG. 4, in the radio protocol in the next-generation mobile communication system, a terminal and an NR base station may include NR service data adaptation protocols (SDAPs) 4-01 and 4-45, NR PDCPs 4-05 and 4-40, NR RLCs 4-10 and 4-35, NR MACs 4-15 and 4-30, and NR PHYs devices (or layers) 4-20 and 4-25, respectively.

The main function of the NR SDAPs 4-01 and 4-45 may include some of the following functions but are not limited thereto:
Transfer of user plane data
Mapping between a QoS flow and a data radio bearer (DRB) for both DL and UL
Marking QoS flow identity (ID) in both DL and UL packets
Reflective QoS flow to DRB mapping for the UL SDAP PDUs.

For an SDAP-layer device, the terminal may receive, through a radio resource control (RRC) message, a configuration as to whether to use a header of the SDAP-layer device or to use a function of the SDAP-layer device function for each PDCP layer device, each bearer, or each logical channel. When an SDAP header is configured, the terminal may be indicated to update or reconfigure, with a non-access stratum (NAS) reflective QoS 1-bit indicator and an access stratum (AS) reflective QoS 1-bit indicator of the SDAP header, mapping information for uplink and downlink QoS flows and a data bearer. According to an embodiment of the disclosure, the SDAP header may include QoS flow ID information indicating the QoS. According to an embodiment of the disclosure, the QoS information may be used as data-processing priority, scheduling information, or like in order to support a smooth service.

The main functions of the NR PDCPs 4-05 and 4-40 may include some of the following functions but are not limited thereto:
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

In the above description, the reordering function of the NR PDCP device may refer to a function of sequentially rearranging PDCP PDUs received in a lower layer, based on a PDCP sequence number (SN). The reordering function of the NR PDCP device may include a function of transferring data to an upper layer in the rearranged order, a function of directly transferring data without considering an order, a function of recording lost PDCP PDUs by rearranging an order, a function of reporting a state of the lost PDCP PDUs to a transmission end, and a function of requesting retransmission of the lost PDCP PDUs.

The main function of the NR RLCs 4-10 and 4-35 may include some of the following functions but are not limited thereto:
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment.

In the above description, the in-sequence delivery function of the NR RLC device may refer to a function of sequentially transferring RLC SDUs received from a lower layer, to an upper layer. When a single RLC SDU is divided into multiple RLC SDUs and the divided multiple RLC SDUs are received, the in-sequence delivery function of the NR RLC device may include a function of rearranging and transferring the same.

The in-sequence delivery function of the NR RLC device may include a function of rearranging the received RLC PDUs, based on an RLC sequence number (SN) or a PDCP sequence number (SN), a function of recording lost RLC PDUs by rearranging an order, a function of reporting the state of the lost RLC PDUs to a transmission end, and a function of requesting retransmission of the lost RLC PDUs.

When there is a lost RLC SDU, the in-sequence delivery function of the NR RLC device may include a function of sequentially transferring only RLC SDUs preceding the lost RLC SDU to the upper layer.

When there is a lost RLC SDU but the timer expires, the in-sequence delivery function of the NR RLC device may include a function of sequentially transferring all RLC SDUs received before a predetermined timer starts to the upper layer.

When there is a lost RLC SDU but the predetermined timer expires, the in-sequence delivery function of the NR RLC device may include a function of transferring all RLC SDUs received up to that point in time to the upper layer.

The NR RLC device may process the RLC PDUs in the received order regardless of the order of serial numbers or sequence numbers, and may deliver the processed RLC PDUs to the NR PDCP device.

When the NR RLC device receives a segment, the NR RLC may receive segments which are stored in a buffer or are to be received later, reconfigure the segments into one complete RLC PDU, and then deliver the same to the NR PDCP device.

The NR RLC layer may not include a concatenation function and may perform the function in the NR MAC layer or may replace the function with a multiplexing function of the NR MAC layer.

In the above description, the out-of-sequence delivery function of the NR RLC device may refer to a function of directly delivering, to the upper layer regardless of order, the RLC SDUs received from the lower layer. When a single RLC SDU is divided into multiple RLC SDUs and the divided multiple RLC SDUs are received, the out-of-sequence delivery function of the NR RLC device may include a function of rearranging and transferring the divided multiple RLC SDUs. The out-of-sequence delivery function of the NR RLC device may include a function of storing the PDCP SN or the RLC SN of each of the received RLC PDUs, arranging the RLC PDUs, and recording the lost RLC PDUs.

The NR MAC 4-15 and 4-30 may be connected to several NR RLC layer devices configured in one terminal, and the main functions of the NR MAC may include some of the following functions but are not limited thereto:
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

NR Physical layers (NR PHYs) 4-20 and 4-25 may generate an OFDM symbol by performing channel-coding and modulating upper-layer data and transmit the same through a radio channel, or may perform demodulating and channel-decoding the OFDM symbol received through the radio channel and transmit the same to the upper layer.

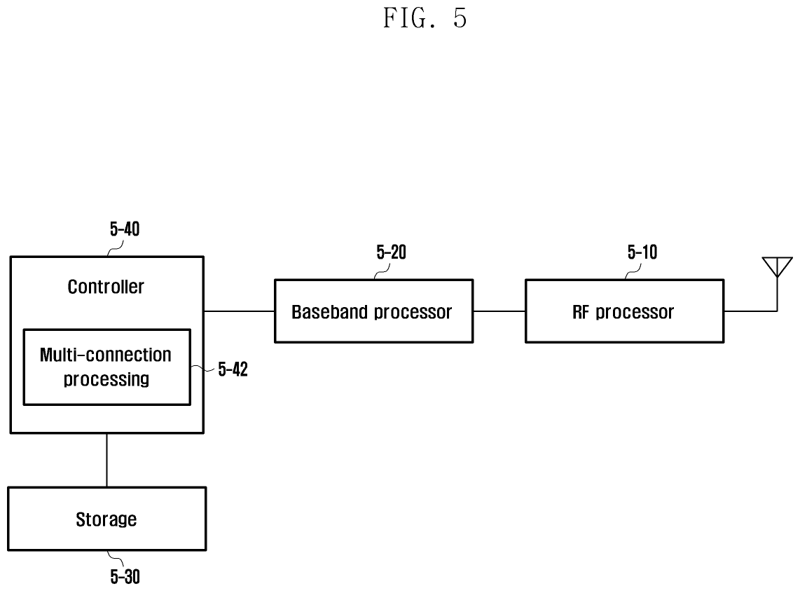

FIG. 5 illustrates a structure of a terminal in a wireless communication system according to an embodiment of the disclosure.

Referring to FIG. 5, the terminal may include a radio frequency (RF) processor 5-10, a baseband processor 5-20, a storage 5-30, and a controller 5-40.

The RF processor 5-10 may perform a function for transmitting or receiving a signal through a radio channel, such as signal band conversion, amplification, and the like. The RF processor 5-10 may up-convert a baseband signal, provided from the baseband processor 5-20, to an RF-band signal and then transmit the RF-band signal through an antenna, and down-convert an RF-band signal received through an antenna into a baseband signal. For example, the RF processor 5-10 may include a transmission filter, a reception filter, an amplifier, a mixer, an oscillator, a digital-to-analog converter (DAC), an analog-to-digital converter (ADC), and the like, but are not limited thereto. Although only a single antenna is illustrated in FIG. 5, the terminal may include multiple antennas. In addition, the RF processor 5-10 may include multiple RF chains. Furthermore, the RF processor 5-10 may perform beamforming. For beamforming, the RF processor 5-10 may adjust the phases and amplitudes of signals transmitted or received through multiple antennas or antenna elements. The RF processor 5-10 may also perform MIMO and may receive data of multiple layers of data during the MIMO operation.

The baseband processor 5-20 performs a function of conversion between a baseband signal and a bitstream according to the physical layer specifications of a system. For example, during data transmission, the baseband processor 5-20 generates complex symbols by encoding and modulating a transmission bitstream. In addition, during data reception, the baseband processor 5-20 may reconstruct a received bitstream by demodulating and decoding a baseband signal provided from the RF processor 5-10. For example, according to an orthogonal frequency-division multiplexing (OFDM) scheme, during data transmission, the baseband processor 5-20 generates complex symbols by encoding and modulating a transmission bitstream, maps the complex symbols to subcarriers, and then configures OFDM symbols by performing inverse fast Fourier transformation (IFFT) operation and cyclic prefix (CP) insertion. Further, during data reception, the baseband processor 5-20 may segment a baseband signal, provided from the RF processor 5-10, into units of OFDM symbols, reconstruct signals mapped to subcarriers by performing a fast Fourier transformation (FFT) operation, and then reconstruct a received bitstream by demodulating and decoding the signals.

The baseband processor 5-20 and the RF processor 5-10 transmit and receive signals as described above. Accordingly, each of the baseband processor 5-20 and the RF processor 5-10 may also be referred to as a transmitter, a receiver, a transceiver, or a communication unit. Furthermore, at least one of the baseband processor 5-20 and the RF processor 5-10 may include multiple communication modules to support multiple different radio-access technologies. In addition, at least one of the baseband processor 5-20 and the RF processor 5-10 may include multiple communication modules to process signals of different frequency bands. For example, the different radio-access technologies may include a wireless local area network (LAN) (e.g., IEEE 802.11), a cellular network (e.g., LTE), and the like. In addition, the different frequency bands may include a super-high frequency (SHF) (e.g., 2·NRHz, NRhz) band and a millimeter-wave (mm Wave) (e.g., 60 GHz) band.

The storage 5-30 stores data, such as basic programs, applications, configuration information, or the like for the operation of the terminal. Specifically, the storage 5-30 may store information related to a second connection node for performing wireless communication by using a second wireless connection technology. In addition, the storage 5-30 provides the stored data in response to a request from the controller 5-40.

The controller 5-40 may include multi-connection processing 5-42 controls the overall operation of the terminal. For example, the controller 5-40 transmits or receives signals through the baseband processor 5-20 and the RF processor 5-10. Further, the controller 5-40 records and reads data on or from the storage 5-30. To this end, the controller 5-40 may include at least one processor. For example, the controller 5-40 may include a communication processor (CP) for controlling communication and an application processor (AP) for controlling an upper layer, such as an application.

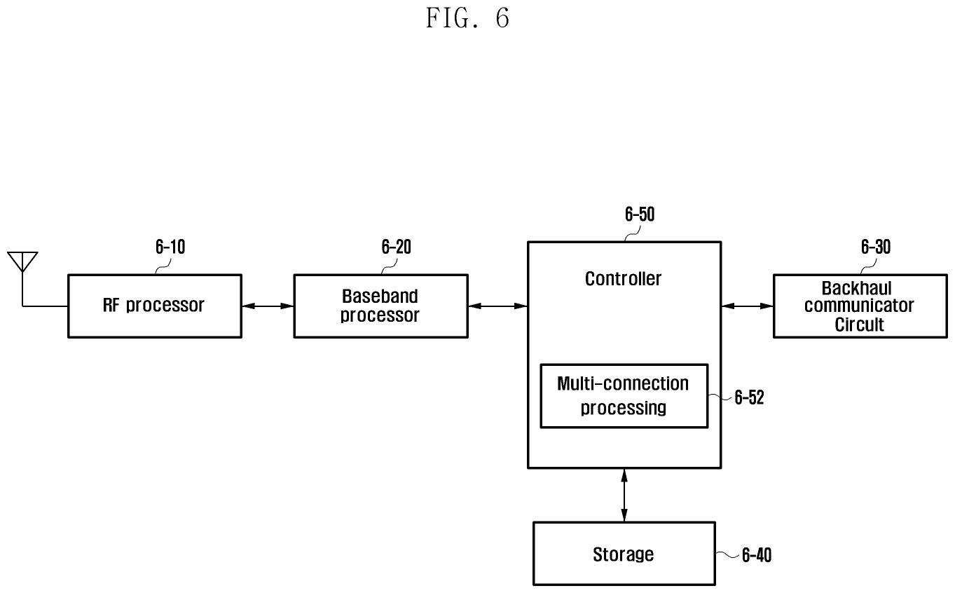

FIG. 6 is a block diagram illustrating a configuration of a base station in a wireless communication system according to an embodiment of the disclosure.

Referring to FIG. 6, the base station may include an RF processor 6-10, a baseband processor 6-20, a backhaul communication unit 6-30, a storage 6-40, and a controller 6-50.

The RF processor 6-10 may perform a function of transmitting or receiving a signal through a radio channel, such as signal band conversion and amplification. The RF processor 6-10 up-converts a baseband signal, provided from the baseband processor 6-20, to an RF-band signal and transmits the converted RF-band signal through an antenna, and down-converts an RF-band signal received through an antenna to a baseband signal. For example, the RF processor 6-10 may include a transmission filter, a reception filter, an amplifier, a mixer, an oscillator, a DAC, an ADC, and the like. Although only a single antenna is illustrated in FIG. 6, the RF processor 6-10 may include multiple antennas. In addition, the RF processor 6-10 may include multiple RF chains. Furthermore, the RF processor 6-10 may perform beamforming. For beamforming, the RF processor 6-10 may adjust phases and amplitudes of signals transmitted or received through multiple antennas or antenna elements. The RF processor 6-10 may perform downlink MIMO operation by transmitting data of one or more layers.

The baseband processor 6-20 may perform conversion between a baseband signal and a bitstream based on the physical layer specifications of a first radio-access technology. For example, during data transmission, the baseband processor 6-20 may generate complex symbols by encoding and modulating a transmission bitstream. In addition, during data reception, the baseband processor 6-20 may reconstruct a received bitstream by demodulating and decoding a baseband signal provided from the RF processor 6-10. For example, according to an OFDM scheme, during data transmission, the baseband processor 6-20 generates complex symbols by encoding and modulating a transmission bitstream, maps the complex symbols to subcarriers, and then configures OFDM symbols by performing IFFT operation and CP insertion. Further, during data reception, the baseband processor 6-20 may segment a baseband signal, provided from the RF processor 6-10, into units of OFDM symbols, reconstructs signals mapped to subcarriers by performing FFT operation, and then reconstruct a received bitstream by demodulating and decoding the signals. The baseband processor 6-20 and the RF processor 610 may transmit and receive signals as described above. Accordingly, each of the baseband processor 6-20 and the RF processor 6-10 may also be referred to as a transmitter, a receiver, a transceiver, a communication unit, or a wireless communication unit.

The backhaul communication unit 6-30 provides an interface for communicating with other nodes in a network. For example, the backhaul communication unit 6-30 may convert a bitstream transmitted from a primary base station to another node, for example, the secondary base station, the core network, and the like, into a physical signal, and may convert a physical signal received from another node into a bitstream.

The storage 6-40 stores data, such as basic programs, applications, configuration information, or the like for the operation of the primary base station. The storage 6-40 may store information related to a bearer allocated to a connected terminal, the result of measurement reported from the connected terminal, and the like. In addition, the storage 6-40 may store information which serves as criteria for determining whether or not to provide multi-connectivity to the terminal. Further, the storage 6-40 provides the stored data in response to a request from the controller 6-50.

The controller 6-50 may include multi-connection processing 6-52 controls the overall operation of the base station. For example, the controller 6-50 transmits or receives a signal through the baseband processor 6-20 and the RF processor 6-10 or through the backhaul communication unit 6-30. In addition, the controller 6-50 records and reads data on or from the storage 6-40. To this end, the controller 6-50 may include at least one processor.

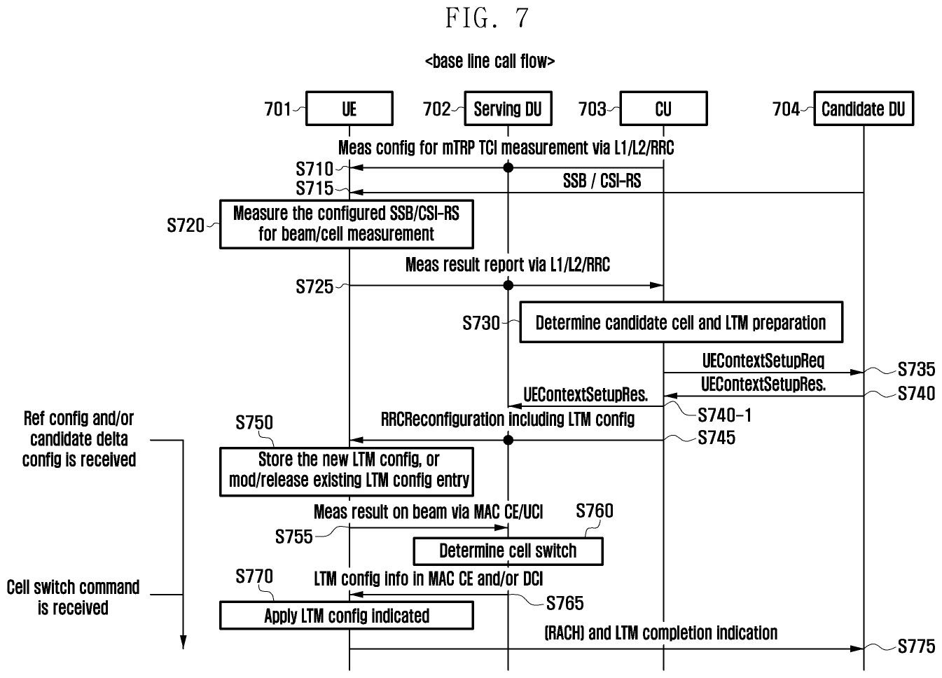

FIG. 7 illustrates an operation of basic lower layer triggered mobility (LTM) according to an embodiment of the disclosure.

LTM can also be expressed as L1 (Layer1)/L2 (Layer2) triggered mobility.

Referring to FIG. 7, a serving cell may be divided into a centralized unit (CU) 703 and a distributed unit (DU) at the network end. A UE 701 can establish a connection state with a cell provided by a serving DU 702 under the CU.

In operation S710, the CU may transmit beam/cell measurement configuration (e.g., Measconfig) for multi-TRP to the UE through the serving DU 702. At this time, the CU may transmit the measurement configuration to the UE using RRC/MAC/DCI, and may transmit, to the UE, information about which cell/beam to measure, which time/frequency domain to measure, which quantity to measure, and which conditions to respond to and report to the network.

In operation S715, the UE may receive SSB or CSI-RS from a candidate DU 704.

In operation S720, the UE that has received this information may measure the SSB or CSI-RS of a given measurement target, that is, the TRP. If the measurement result of a cell and/or beam of the measurement target included in a report configuration for this measurement meet the report conditions, the UE may report the measurement result to the CU in operation S725. At this time, the reported measurement result may be transmitted through UCI, MAC CE, or UL RRC message.

In operation S730, the CU that has received the measurement result report may determine an LTM candidate cell.

In operation S735, the CU may request an LTM handover to the candidate DU 704 that is operating the determined candidate cell. For example, the LTM handover request may be transmitted through a UE context setup request message.

In operation S740, the candidate DU that has received this request may accept and/or reject the request. If accepted, configuration information to be used in the target cell may be contained in an acceptance message and transmitted to the CU. For example, the acceptance message may be transmitted through a UE context setup response message. At this time, the information transmitted by the candidate DU may be a cell group configuration to be used in the target cell. In operation S740-1, the CU that has received the acceptance message through the UE context setup response message may deliver the UE context setup response message to the serving DU 702.

In operation S745, after receiving the cell group configuration of the target cell, the CU may add configuration information managed only by the CU, such as the remaining radio bearer and meas config, and transmit complete configuration information (e.g., LTM config) for a specific candidate cell to the UE through the serving cell of the serving DU 702. For example, complete configuration information (e.g., LTM config) for the specific candidate cell may be included in RRCReconfiguration and may be delivered to the UE through RRCReconfiguration.

Before or after the above step, the CU may inform the serving DU 702 that the LTM configuration for a specific candidate cell is transmitted to the UE. The serving DU 702 may store information on corresponding candidate cells.

In operation S750, the UE that has received the configuration information of a specific candidate target cell from the CU may store the received information. If there is the existing LTM configuration previously stored, the UE may change or release the existing configuration.

In operation S755, the UE may transmit the measurement result to the serving DU 702 through the network when the conditions according to previously received measurement configuration are satisfied or at a given time. At this time, the UE may transmit the measurement result through a UCI/MAC CE message, and the cell signal strength of other cell and/or the beam signal strength of other cell, etc. may be transmitted.

In operation S760, the serving DU 702 that has received this report may determine a cell switch to one of the LTM candidate cells previously configured by the UE from the CU, if necessary, and in operation S765, the serving DU 702 may send a cell switch command to the UE. At this time, the serving DU 702 may command the cell switch to a specific target cell through MAC CE and/or DCI. Information on the cell switch command may be transmitted to the UE along with the LTM configuration information of the target cell.

Upon receiving the cell switch command, the UE may perform a handover to the target cell by performing an operation to apply the LTM configuration of the indicated target cell in operation S770. In operation S775, the UE may perform a random access procedure to the target cell, and when random access is successfully completed, transmit an indicator indicating the completion of LTM performance to the target cell via a UCI/MAC CE/UL RRC message.

Based on the description of FIG. 7, the disclosure can assume the followings:
The candidate cell configuration to be used by the UE in the candidate cell for LTM may be in the unit of an RRCReconfiguration message.
Therefore, when the UE receives the cell switch command, the configuration applied by the UE may be RRCReconfiguration for LTM. This may be referred to as complete configuration.
When the network signals the complete configuration, it may be delivered directly to the UE, or it may be composed of a reference configuration and a candidate delta configuration and delivered to the UE.
If the reference configuration and the candidate delta configuration are configured separately, the candidate delta configuration may be applied on top of the reference configuration to form a complete configuration.
In the case where the cell switch is commanded, the complete configuration may be applied to the UE when the cell switch is performed, and may replace the current UE configuration. At this time, the RRC reconfiguration procedure may be applied.

### (Assumption:

Per candidate cell configuration to be used at UE is RRCReconfiguration
Final object to be applied at UE at cell switch is RRCReconfiguation

If there is separate reference configured at UE, candidate delta configuration is applied on top of the reference configuration to form a complete candidate configuration.

The complete candidate configuration is applied and replacing the current UE configuration (at the time of reconfiguration execution/cell switch), by a RRC reconfiguration procedure that makes replacements of configuration but doesn't necessarily reset RLC or PDCP.)

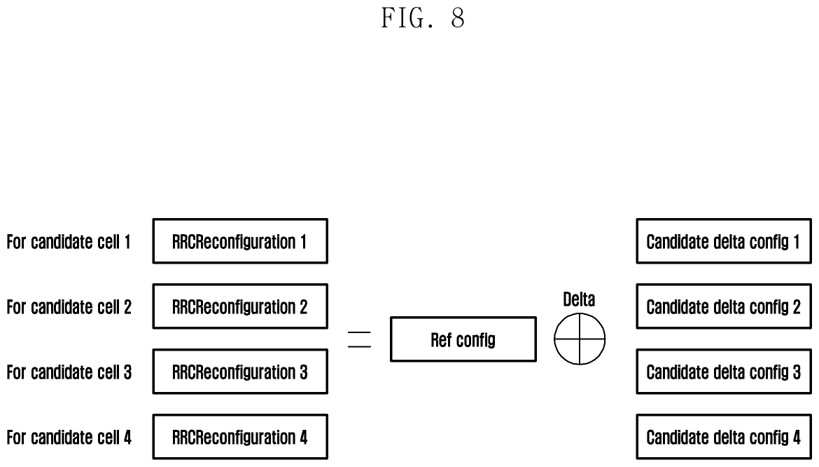

FIG. 8 illustrates a scheme of forming a complete configuration when a reference configuration and a candidate delta configuration are applied according to an embodiment of the disclosure.

Referring to FIG. 8, in the case where a reference configuration is given to the UE, one or more reference configurations may be given, and a separate candidate delta configuration corresponding to each candidate cell may be delivered to the UE. The configurations delivered through the above structure may be formed by the UE into the complete configuration at a specific point in time. In this case, one complete configuration may be made by applying the candidate delta configuration associated with a specific candidate cell as delta configuration for one reference configuration, and the complete configuration may be used in the candidate cell associated with the candidate delta configuration.

The disclosure describes, when the reference configuration is introduced, what information will be included in the reference configuration, and various operations of the UE in the complete configuration derivation step for each case.

The UE may be configured with multiple reference configurations (Opt. A) or a single reference configuration (Opt. B) from the CU.

The Opt. A and Opt. B may have the following pros and cons.

### Qualitative Assessment:

Opt. A. can have some signaling overhead for maintaining multiple reference configs, but if there are many candidate cells, candidate delta config signaling has less size.

Opt. B. there is less overhead for managing reference config, but final delta/or full configuration size is higher.

Opt. A. In the case where multiple reference configurations (i.e., reference config) are configured, each reference configuration may be assigned a certain ID. For example, this ID may be contained in the reference configuration, or the ID and the reference configuration may be contained together in a separate field to indicate that the ID and the corresponding configuration are associated.

For example, this ID may be assigned by the CU.

In this case, each candidate delta configuration delivered together to the UE may contain an ID indicating the reference configuration to be combined therewith, or this ID and the candidate delta configuration may be contained together in a separate field to indicate that the reference configuration of this ID and the candidate delta configuration should be combined.

The network may use the corresponding reference configuration ID in add/mod/release operations. For example, in the case of a reference configuration that did not exist before, the UE may add and store it in a storage variable. A reference configuration delivered along with the ID of the existing reference configuration can modify the existing reference configuration corresponding to the ID to the newly received reference configuration. If the release and the ID are delivered together, the UE can delete configuration corresponding to the ID of the existing reference configuration from its storage.

When the network transmits the candidate delta configuration to the UE, if the ID field indicating the reference configuration to be combined is absent, contains an indicator not to use the reference configuration, or contains an indicator called full configuration, the candidate delta configuration may be a complete configuration by itself without being combined with the reference configuration.

Opt. B. In the case of signaling a single reference configuration, the network may instruct to add, modify, or release the reference configuration. In this case, the field itself may indicate add, modify, or release without an ID. For this purpose, the UE may store the reference configuration in a storage variable.

When the network transmits the candidate delta configuration to the UE, if an indicator not to use the reference configuration is contained, or an indicator called full configuration is contained, the candidate delta configuration may be a complete configuration by itself without being combined with the reference configuration.

The above-described Opt. A and Opt. B may equally follow the reference configuration signaling scheme (e.g., Opt. 1/Opt. 2/Opt. 3) below.

Opt. 1. The reference configuration may reuse part or all of the current UE's configuration information, and the network may give instructions for this to the UE. Specifically, the indication for the reference config may be based on one of Opt. 1-1, Opt. 1-2, Opt. 1-3, or Opt. 1-4.

Opt 1-1: A (1 bit) indicator may be contained in the most outer RRCReconfiguration message created by a master node (MN) and delivered via Signalling Radio Bearer 1 (SRB1). In this case, the location within the RRCReconfiguration may be at the same topology as the cell group configuration field or outside the cell group configuration field (i.e., the shallowest field location of the RRCReconfiguration message).

(Opt. 1-1: within the most outer RRCReconfiguration received from MN which can be received via SRB1 or MN RRCReconfiguration message which can be received via SRB1, but outside of any cellGroupConfig fields.)

This may actually mean the RRCReconfiguration itself created by the corresponding MN.

In this case, for all fields in the RRCReconfiguration, the candidate delta configuration marks unnecessary configuration as absent, explicitly marks configuration, which needs to be added, with a value of the corresponding field, and marks configuration, which needs to be changed, with a different value. By doing this, delta combining scheme can be performed.

(Candidate delta config would have baseline of outer RRCReconfig, i.e., can include MCG and/or SCG and/or radioBearer config and/or measConfig)

Table 1 is an ASN.1 example.

TABLE 1
RRCReconfiguration-IEs (this RRCReconfig msg is the most outer one)::=
SEQUENCE {

| | |
|---|---|
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL

| | |
|---|---|
| LTM-ref | ENUMURATED{yes} |

}

In Table 1, LTM-ref may mean that the RRCReconfiguration is used as the reference configuration.

Opt. 1-2: A (1-bit) indicator may be contained in the shallowest field location within the cell group configuration field.

TABLE 2

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF |
| RLC-BearerConfig | OPTIONAL, -- Need N |
| rlc-BearerToReleaseList | SEQUENCE (SIZE(1..maxLC-ID)) OF |
| LogicalChannelIdentity | OPTIONAL, -- Need N |
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE (1..maxNrofSCells)) OF |

| | |
|---|---|
| SCellConfig | OPTIONAL, -- Need N |

| | |
|---|---|
| sCellToReleaseList | SEQUENCE (SIZE (1..maxNrofSCells)) OF |

| | |
|---|---|
| SCellIndex | OPTIONAL, -- Need N |

```
  ...,
  [[
```

| | |
|---|---|
| reportUplinkTxDirectCurrent | ENUMERATED {true} |

```
OPTIONAL -- Cond BWP-Reconfig
  ]],
  [[
```

| | |
|---|---|
| bap-Address-r16 | BIT STRING (SIZE (10)) |

OPTIONAL, -- Need M

| | |
|---|---|
| bh-RLC-ChannelToAddModList-r16 | SEQUENCE (SIZE(1..maxBH- |

RLC-ChannelID-r16)) OF BH-RLC-ChannelConfig-r16 OPTIONAL, -- Need N

| | |
|---|---|
| bh-RLC-ChannelToReleaseList-r16 | SEQUENCE (SIZE(1..maxBH-RLC- |

ChannelID-r16)) OF BH-RLC-ChannelID-r16 OPTIONAL, -- Need N

| | |
|---|---|
| f1c-TransferPath-r16 | ENUMERATED {lte, nr, both} |

OPTIONAL, -- Need M

| | |
|---|---|
| simultaneousTCI-UpdateList1-r16 | SEQUENCE (SIZE |

(1..maxNrofServingCellsTCI-r16)) OF ServCellIndex OPTIONAL, -- Need R

| | |
|---|---|
| simultaneousTCI-UpdateList2-r16 | SEQUENCE (SIZE |

(1..maxNrofServingCellsTCI-r16)) OF ServCellIndex OPTIONAL, -- Need R

| | |
|---|---|
| simultaneousSpatial-UpdatedList1-r16 | SEQUENCE (SIZE |

(1..maxNrofServingCellsTCI-r16)) OF ServCellIndex OPTIONAL, -- Need R

| | |
|---|---|
| simultaneousSpatial-UpdatedList2-r16 | SEQUENCE (SIZE |

(1..maxNrofServingCellsTCI-r16)) OF ServCellIndex OPTIONAL, -- Need R

| | |
|---|---|
| uplinkTxSwitchingOption-r16 | ENUMERATED {switchedUL, dualUL} |

OPTIONAL, -- Need R

| | |
|---|---|
| uplinkTxSwitchingPowerBoosting-r16 | ENUMERATED {enabled} |

OPTIONAL -- Need R

| | |
|---|---|
| LTM-ref | ENUMURATED{yes} |

]],

In Table 2, LTM-ref may indicate that the cell group configuration should be used as the reference configuration.

In this case, a master cell group (MCG) and/or a secondary cell group (SCG) may each be the reference configuration. For example, the topology and context of the MCG or SCG cell group configuration in RRCReconfiguration may be the reference configuration. In this case, because configurations not included in the cell group configuration are always assumed to be absent, the candidate delta configuration must always include the corresponding fields if necessary.

According to the above method, if it is impossible to configure dual connectivity (DC) to the UE in the target cell, only the MCG cell group configuration of the current UE can be used as the reference configuration. For example, even if the SCG cell group configuration has a reference configuration indicator, it may be considered not present when creating the complete configuration.

If DC configuration for the UE is possible in the target cell, two configurations, that is, the current MCG and SCG configurations, can each be the reference configuration. Because of having to consider both MCG and SCG as the reference configuration, the candidate delta configuration must configure to release unnecessary fields in the reference within each cell group configuration, and must include configuration to add necessary fields.

This method can reduce signaling overhead as there are more candidate cells in one DU.

Opt. 1-3: A (1-bit) indicator may be contained in special cell (spcell) configuration.

In this case, the indicator may be contained in the spcell configuration field of each MCG and/or SCG.

Likewise, the topology and context of spcell configuration in RRCReconfiguration may be the reference configuration. Therefore, the candidate delta configuration may be formed by releasing unnecessary content and adding necessary content based on the context of the current UE's spcell configuration. Instead, all information not contained in the spcell configuration field must be contained in the candidate delta configuration when necessary.

This scheme can reduce signaling overhead when carrier aggregation (CA) is not considered for the UE or when the spcell configuration having the many same parts is used.

Opt. 1-4: A radioBearerConfig and/or measConfig can be the reference configuration. In addition, each field may contain an indicator indicating the reference configuration. Alternatively, without this indicator, independent and separate configuration of radioBearerConfig and/or measConfig may be marked.

TABLE 3
RRCReconfiguration-IEs (for reference configuration) ::= SEQUENCE {

| | |
|---|---|
| radioBearerConfig | CHOICE { |
| explicitConfig | RadioBearerConfig, |
| usePCell-Config | NULL |

| | |
|---|---|
| }, | OPTIONAL, -- Need M |

| | |
|---|---|
| secondaryCellGroup | OCTET STRING (CONTAINING |
| CellGroupConfig) | OPTIONAL, -- Cond SCG |
| measConfig | CHOICE { |
| explicitConfig | MeasConfig |
| usePCell-Config | NULL |

| | |
|---|---|
| }, | OPTIONAL, -- Need M |

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

In the ASN.1 example of Table 3 above, when usePcell-Config is indicated, radioBearerConfig of the current UE and/or measConfig of the current UE may be indicted to be used as the reference configuration. If explicitConfig is indicated in the above example, separate radioBearerConfig unrelated to the current UE's configuration and/or separate measconfig unrelated to the current UE's measConfig may be contained, and this may be instructed to the UE.

In the above cases of Opt. 1, if the LTM reference configuration indicator does not exist in any of the current UE's configurations, the UE may regard the candidate delta configurations as the complete configurations.

Opt. 2: This is a case where the LTM specific field indicates which part of the current UE is used as the reference configuration.

It is possible to express which part is used as the reference configuration, based on one of the following units:
{Current UE's RRCReconfiguration applied,
and/or current UE's MCG configuration applied,
and/or current UE's SCG configuration applied,
and/or current UE's spcell configuration (which further indicated with MCG or SCG).
And/or current radioBearerConfig
And/or current measConfig}

Based on the current UE's configuration of the above unit, the candidate delta configuration may be formed by directly adding all necessary fields other than the corresponding unit, marking a changed value in a field desired to be changed, among fields within the unit, and making a field desired to be released to absent.

Opt. 3. The reference configuration may be transferred to the UE as a separate configuration regardless of the current UE's configuration. In this case, it may be contained in the LTM specific field, contained in a separate field called reference configuration, or associated with an indicator.

If the LTM specific field containing the reference configuration is absent, the candidate delta configuration may be indicated to the UE as the complete configuration that does not require delta configuration.

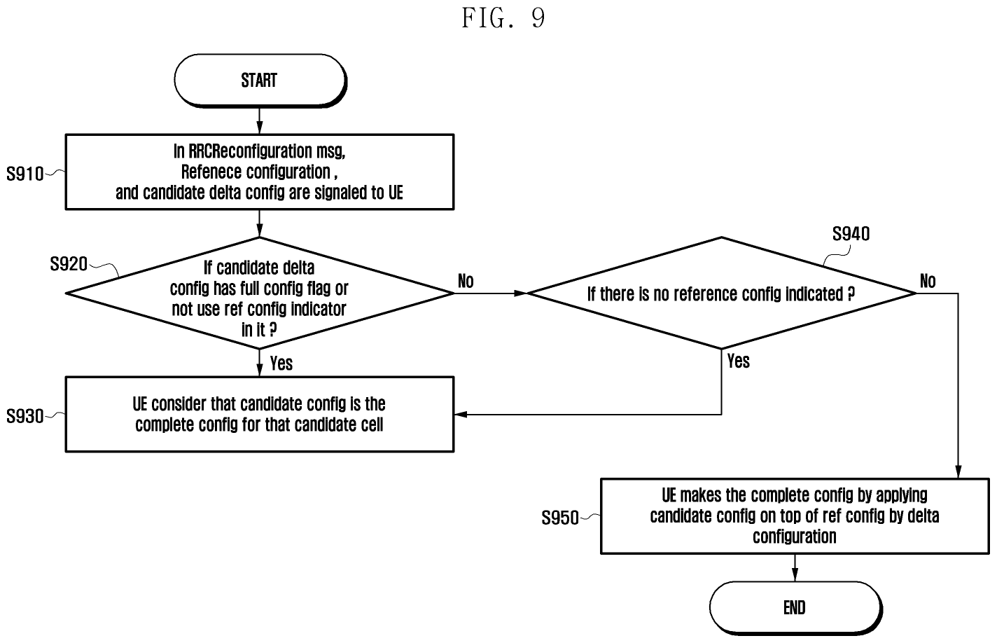

FIG. 9 illustrates a UE operation to make a complete configuration when a reference configuration and a candidate delta configuration are given according to an embodiment of the disclosure.

Referring to FIG. 9, in operation S910, the UE may receive an RRCReconfiguration message. For example, the RRCReconfiguration message received by the UE may include both a reference configuration and a candidate delta configuration.

In operation S920, for a specific candidate cell, the UE may determine whether the candidate delta configuration has a full configuration flag or an indicator not to use a reference configuration.

If the candidate delta configuration has a full configuration flag or an indicator not to use a reference configuration for a specific candidate cell, in operation S930, the UE may regard the candidate delta configuration as a complete configuration.

If not, in operation S940, the UE may determine whether a reference configuration exists. If the reference configuration does not exist, the UE may regard the candidate delta configuration as a complete configuration, similar to the operation S930.

If there is no full config flag and the reference configuration exists, in operation S950, the UE may create a complete candidate configuration by applying the candidate delta configuration to the reference configuration. This operation may be performed repeatedly for each candidate cell.

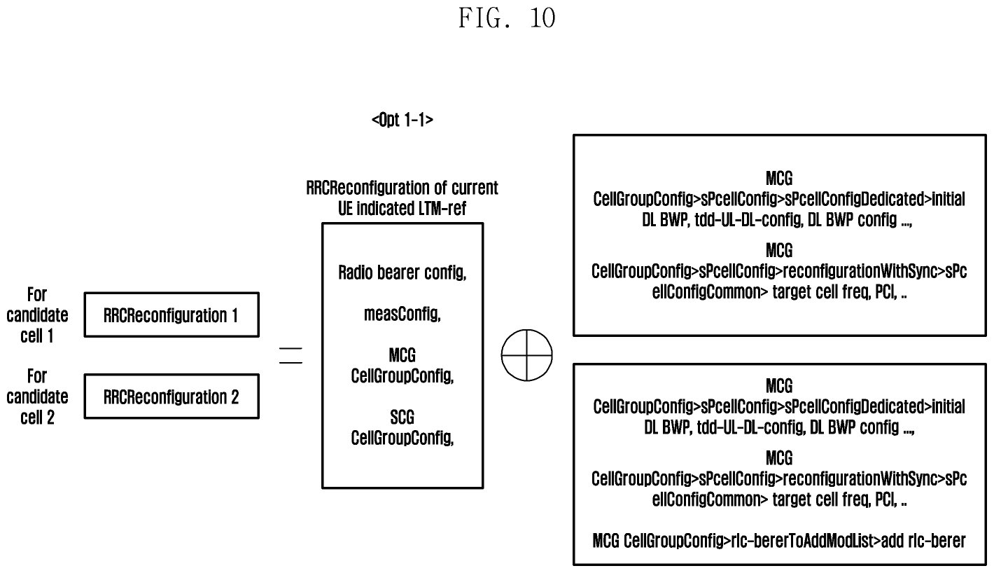

FIG. 10 illustrates a process of making a complete configuration when an RRCReconfiguration message of a current UE is a reference configuration according to an embodiment of the disclosure.

Referring to FIG. 10, it shows a case where the UE receives a reference configuration that contains an indicator in an RRCReconfiguration field received as the current UE configuration. In other words, it may correspond to Opt. 1-1 described above. It can be assumed that an LTM candidate delta configuration received along with this message is configured to the UE, including a candidate delta configuration for each of cell 1 and cell 2.

For candidate cell 1, the complete configuration of cell 1 may be considered by using measConfig and radioBearer config in current RRCReconfiguration as they are, using the rest as it is, changing information, such as initial DL BWP, tdd-UL-DL-config, and DL BWP config in MCG CellGroupConfig>sPcellConfig>sPcellConfigDedicated field to information for target cell 1, and also changing target cell freq and PCI in MCG CellGroupConfig>sPcellConfig>reconfiguration WithSync>sPcellConfigCommon field to the freq and PCI of candidate cell 1.

For candidate cell 2, the complete configuration of cell 2 may be considered by using measConfig and radioBearer config in current RRCReconfiguration as they are, using the rest as it is, changing information, such as initial DL BWP, tdd-UL-DL-config, and DL BWP config in MCG CellGroupConfig>sPcellConfig>sPcellConfigDedicated field to information for target cell 2, also changing target cell freq and PCI in MCG CellGroupConfig>sPcellConfig>reconfiguration WithSync>sPcellConfigCommon field to the freq and PCI of candidate cell 2, and further adding an RLC bearer, that is, MCG CellGroupConfig>rlc-bererToAddModList>add rlc-berer.

The above-described embodiments and methods of the disclosure may be performed in combination with each other.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), an electrically erasable programmable read only memory (EEPROM), memory chips, device or integrated circuits or on an optically or magnetically readable medium such as, for example, a compact disc (CD)-ROM, digital versatile discs (DVDs), other type optical storage devices, magnetic disk or a magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

In addition, the programs may be stored in an attachable storage device which may access the electronic device through communication networks, such as the Internet, Intranet, a local area network (LAN), a wide LAN (WLAN), and a storage area network (SAN) or a combination thereof. Such a storage device may access the electronic device via an external port. Further, a separate storage device on the communication network may access a portable electronic device.

In the specific embodiments of the disclosure described above, components included in the disclosure are expressed in singular or plural numbers depending on the specific embodiment presented. However, singular or plural expressions are selected to suit the presented situation for convenience of explanation, and the disclosure is not limited to singular or plural components, and even components expressed in plural may be composed of singular or singular. Even expressed components may be composed of plural elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
identifying that a lower layer triggered mobility (LTM) cell switch is triggered;
identifying a reference configuration and a candidate configuration associated with LTM;
identifying whether information indicating that the candidate configuration is a complete configuration is included in the candidate configuration; and
applying a radio resource control (RRC) reconfiguration message for the LTM cell switch,
wherein the RRC reconfiguration message is based on at least one of the reference configuration or the candidate configuration depending on whether the information indicating that the candidate configuration is the complete configuration is included in the candidate configuration.

2. The method of claim 1, wherein in case that the information indicating that the candidate configuration is the complete configuration is not included in the candidate configuration, the RRC reconfiguration message is generated by applying the candidate configuration on top of the reference configuration.

3. The method of claim 1, wherein in case that the information indicating that the candidate configuration is the complete configuration is included in the candidate configuration, the RRC reconfiguration message is an RRC reconfiguration message in the candidate configuration.

4. The method of claim 1, wherein the identifying of the LTM cell switch being triggered comprises receiving command information for the LTM cell switch via medium access control-control element (MAC-CE) or downlink control information (DCI).

5. The method of claim 1, wherein the reference configuration includes an RRC configuration message.

6. A method performed by a base station in a wireless communication system, the method comprising:
transmitting, to a terminal, a reference configuration and a candidate configuration associated with lower layer triggered mobility (LTM);
determining to trigger a LTM cell switch; and
transmitting, to the terminal, command information for the LTM cell switch,
wherein a radio resource control (RRC) reconfiguration message for the LTM cell switch is based on at least one of the reference configuration or the candidate configuration depending on whether information indicating that the candidate configuration is a complete configuration is included in the candidate configuration.

7. The method of claim 6, wherein in case that the information indicating that the candidate configuration is the complete configuration is not included in the candidate configuration, the RRC reconfiguration message is based on applying the candidate configuration on top of the reference configuration.

8. The method of claim 6, wherein in case that the information indicating that the candidate configuration is the complete configuration is included in the candidate configuration, the RRC reconfiguration message is an RRC reconfiguration message in the candidate configuration.

9. The method of claim 6, wherein the command information is transmitted via medium access control-control element (MAC-CE) or downlink control information (DCI).

10. The method of claim 6, wherein the reference configuration includes an RRC configuration message.

11. A terminal in a wireless communication system, the terminal comprising:
a transceiver; and
a controller configured to:
identify that a lower layer triggered mobility (LTM) cell switch is triggered,
identify a reference configuration and a candidate configuration associated with LTM,
identify whether information indicating that the candidate configuration is a complete configuration is included in the candidate configuration, and
apply a radio resource control (RRC) reconfiguration message for the LTM cell switch,
wherein the RRC reconfiguration message is based on at least one of the reference configuration or the candidate configuration depending on whether the information indicating that the candidate configuration is the complete configuration is included in the candidate configuration.

12. The terminal of claim 11, wherein in case that the information indicating that the candidate configuration is the complete configuration is not included in the candidate configuration, the RRC reconfiguration message is generated by applying the candidate configuration on top of the reference configuration.

13. The terminal of claim 11, wherein in case that the information indicating that the candidate configuration is the complete configuration is included in the candidate configuration, the RRC reconfiguration message is an RRC reconfiguration message in the candidate configuration.

14. The terminal of claim 11, wherein to identify that the LTM cell switch is triggered, the controller is configured to receive command information for the LTM cell switch via medium access control-control element (MAC-CE) or downlink control information (DCI).

15. A base station in a wireless communication system, the base station comprising:
a transceiver; and
a controller configured to:
transmit, to a terminal, a reference configuration and a candidate configuration associated with lower layer triggered mobility (LTM),
determine to trigger a LTM cell switch, and
transmit, to the terminal, command information for the LTM cell switch,
wherein a radio resource control (RRC) reconfiguration message for the LTM cell switch is based on at least one of the reference configuration or the candidate configuration depending on whether information indicating that the candidate configuration is a complete configuration is included in the candidate configuration.

16. The base station of claim 15, wherein in case that the information indicating that the candidate configuration is the complete configuration is not included in the candidate configuration, the RRC reconfiguration message is based on applying the candidate configuration on top of the reference configuration.

17. The base station of claim 15, wherein in case that the information indicating that the candidate configuration is the complete configuration is included in the candidate configuration, the RRC reconfiguration message is an RRC reconfiguration message in the candidate configuration.

18. The base station of claim 15, wherein the command information is transmitted via medium access control-control element (MAC-CE) or downlink control information (DCI).

19. One or more non-transitory computer-readable storage media storing computer-executable instructions that, when executed by one or more processors of a terminal, cause the terminal to perform operations, the operations comprising:
identifying that a lower layer triggered mobility (LTM) cell switch is triggered;
identifying a reference configuration and a candidate configuration associated with LTM;
identifying whether information indicating that the candidate configuration is a complete configuration is included in the candidate configuration; and
applying a radio resource control (RRC) reconfiguration message for the LTM cell switch,
wherein the RRC reconfiguration message is based on at least one of the reference configuration or the candidate configuration depending on whether the information indicating that the candidate configuration is the complete configuration is included in the candidate configuration.

20. The one or more non-transitory computer-readable storage media of claim 19, wherein in case that the information indicating that the candidate configuration is the complete configuration is not included in the candidate configuration, the RRC reconfiguration message is generated by applying the candidate configuration on top of the reference configuration.
